(19) United States
(12) Patent Application Publication
(10) Pub. No.: US 2023/0196706 A1
(43) Pub. Date: Jun. 22, 2023

(54) ACCESSIBLE GUIDED IMAGE CAPTURE SYSTEMS AND METHODS

(71) Applicant: T-Mobile USA, Inc., Bellevue, WA (US)

(72) Inventor: Kade Scott, Bellevue, WA (US)

(21) Appl. No.: 17/558,274

(22) Filed: Dec. 21, 2021

(51) Int. Cl. G06V 10/22; G06V 10/25; G06V 10/24; H04N 5/232; G06V 10/98

(52) U.S. Cl. CPC G06V 10/225; G06V 10/235; G06V 10/25; G06V 10/24; H04N 5/23222; G06V 10/993

(57) ABSTRACT

Systems and methods that provide accessible guidance to users when they are attempting to capture images of an object are disclosed. The accessible guided image capture system evaluates a set of images captured by a capturing device to identify attributes of an object, such as edges, sides, corners, and so on. The accessible guided image capture system uses the identified object attributes to identify a direction in which the mobile device is to be repositioned relative to the object in order to capture better images of the object. The accessible guided image capture system can then use the computed direction to transmit a set of instructions (e.g., haptic signals) to enable the repositioning of the capturing device relative to the object.

### BACKGROUND

It is commonplace now to capture images of objects using mobile devices. The captured images can then be used in various applications. For example, mobile check deposit tools allow a user to take a photo of a check and deposit the check to a bank account using a phone or mobile device. Instead of depositing checks at the ATM, the bank's drive-through window, or with a teller inside the lobby, a user can add them to an account from wherever they happen to be, whether that's at home, work, or on vacation. While this technology has been welcomed by most consumers, the convenience comes with some challenges relating to image capture. A common problem with such image capture tools is that it is difficult to position the mobile camera appropriately, relative to the object, so that a complete and accurate digital image of the object can be captured. Often, a user operating the mobile device has to perform a lot of trial and error by moving the mobile device around before an acceptable image of the object is captured.

Further, depending on the application of the image, it is often important to ensure that the image of the object is captured at the right resolution and clarity. As an example, in the scenario where the object is a check and its image is being used to deposit the check with a financial institution, the deposit may be rejected because the image did not meet visual specifications or the information on the check is missing or incorrect. Many times this problem is corrected by simply snapping another picture of the check and resubmitting. However, the rejected deposit can lead to financial loss if the user is not diligent about checking the account and notifications. If the user fails to notice the rejected deposit, it's possible that the funds will never be deposited. The funds could then easily be lost if the user does not balance his or her account, especially if it is a small deposit.

These problems are further amplified for users with different abilities, such as those who are visually impaired. While existing image capture tools provide some sort of visual guidance to a user attempting to capture an image using a mobile device, such guidance does not help those with visual imparities.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a flow diagram that illustrates a process performed by the accessible guided image capture system in some implementations.

FIGS. 3A-3E are block diagrams that illustrate the guidance provided by the accessible guided image capture system in some implementations.

FIG. 4 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

To solve these and other problems of existing image capture solutions, the inventor has conceived and reduced to practice systems and methods that provide accessible guidance to users when they are attempting to capture images of an object (“accessible guided image capture system”). The accessible guided image capture system evaluates a set of images captured by a capturing device (e.g., a camera of a mobile phone) to identify attributes of an object, such as edges, sides, corners, and so on. The accessible guided image capture system uses the identified object attributes to identify a direction in which the mobile device is to be repositioned relative to the object in order to capture better images of the object. For example, the accessible guided image capture system can determine that it has received images of a left portion of a rectangular object but is missing images of a right bottom corner of the object. Using this information, the accessible guided image capture system can determine that the mobile device should be moved in a horizontal direction towards the right side of the object to capture the missing object information. The accessible guided image capture system can then use the computed direction to transmit a set of instructions to enable the repositioning of the capturing device relative to the object. For example, the accessible guided image capture system can send instructions to activate haptic devices that emit vibrations on the right side of the mobile device to signal to the user that they should move the mobile device towards a horizontal right direction relative to the object in order to capture or revise object images.

In some aspects, the techniques described herein relate to a mobile device for providing accessible guided directions for capturing images, the mobile device including: a capturing device to capture a set of images of an object; at least one hardware processor; at least one non-transitory memory coupled to the at least one hardware processor and storing instructions, which, when executed by the at least one hardware processor, perform a process, the process including: evaluating the set of images captured by the capturing device to identify at least one attribute of the object (e.g., an edge, a side, a corner, color, hue, brightness, luminosity, intensity, and so on); identifying a portion of the object that is not visible in the captured set of images based on the identified at least one attribute of the object; using the identified portion of the object that is not visible in the captured set of images, computing at least one direction in which the capturing device is to be repositioned relative to the object in order to capture a revised set of images of the object; using the computed at least one direction, selecting one or more output devices from a set of output devices (e.g., a haptic device, a speaker, a graphical user interface, etc.); and transmitting a set of instructions (e.g., haptic signals, audio signals, video signals, image signals, and so on) to the selected one or more output devices to enable the repositioning of the capturing device relative to the object, wherein at least a portion of the set of instructions are outputted via the selected one or more output devices, and wherein the set of instructions identify a physical direction of movement (e.g., a direction in an X axis, a Y axis, a Z axis, or any combination thereof) corresponding to the computed at least one direction. Transmitting the set of instructions can facilitate movement of the capturing device relative to the object or movement of the object relative to the capturing device. In some implementations, the mobile device captures, using the capturing device, the revised set of images of the object after the capturing device is repositioned relative to the object. The revised set of images can then be used to generate and store a digital version of the object.

In some aspects, the techniques described herein relate to a computer program product for providing accessible guided directions for capturing images, the computer program product being embodied in a non-transitory computer-readable medium and including computer instructions for: receiving a first set of images of an object; evaluating the first set of images to identify at least one attribute of the object including one or more of: an edge of the object, a side of the object, or a corner of the object; using the identified at least one attribute of the object, computing at least one direction in which the capturing device is to be repositioned relative to the object in order to capture a revised set of images of the object; and using the computed at least one direction, transmitting a set of instructions to enable the repositioning of the capturing device relative to the object, wherein the set of instructions identify one or more physical directions of movement corresponding to the computed at least one direction. The computer instruction can further include: identifying a portion of the object that is not visible in the first set of images based on the identified at least one attribute of the object, wherein the computed at least one direction is based on the identified portion of the object that is not visible in the first set of images. The computed at least one direction can be used to select one or more output devices from a set of output devices including at least one of a haptic device or a speaker and transmit a set of instructions to the selected one or more output devices to enable the repositioning of the capturing device relative to the object, wherein at least a portion of the set of instructions are outputted via the selected one or more output devices.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

Wireless Communications System

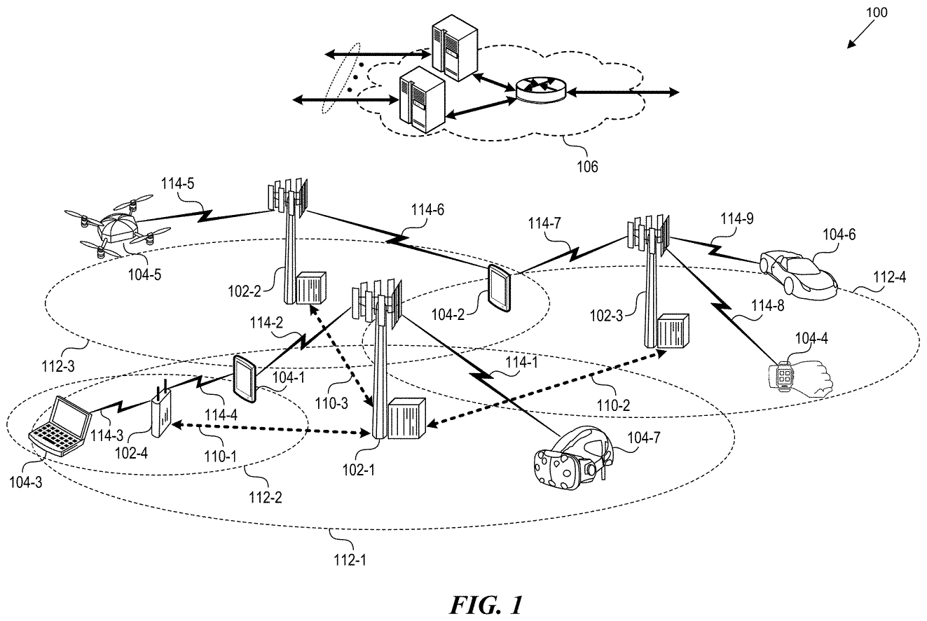

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WVAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed or unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG) or wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the wireless telecommunications network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (ARNR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

Accessible Guided Image Capture Systems and Methods

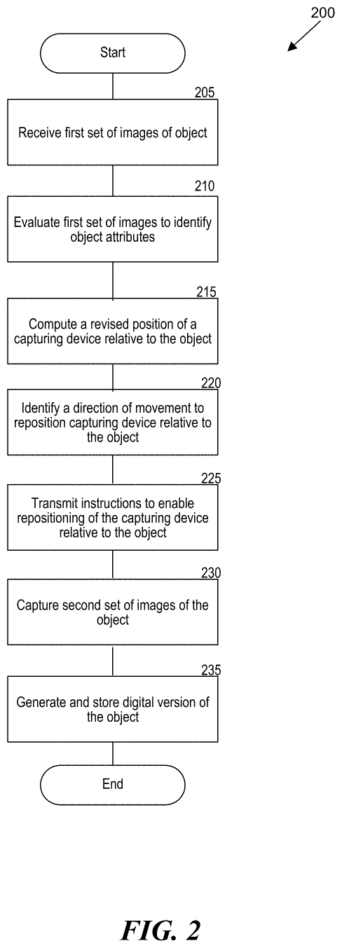

FIG. 2 is a flow diagram that illustrates a process 200 performed by the accessible guided image capture system in some implementations. Process 200 can be performed by a user equipment, such as a mobile device. At block 205, process 200 receives a first set of images of an object. The first set of images can be captured by a capturing device (e.g., one or more cameras) of the mobile device and/or other devices (e.g., a wearable device) communicatively coupled to the mobile device. For example, the first set of images are captured using one or more cameras of a smartphone. As another example, the first set of images are captured using one or more cameras of a VR headset. In other examples, the first set of images can be captured using two or more devices, such as cameras in a mobile device and a VR headset. In some implementations, the first set of images are captured using one or more cameras of an AR headset where the physical image is translated to a digital AR artifact of the same image (scanning the physical item creates a digital copy of the same item). In some examples, the first set of images can be captured using one or more cameras of an AR headset where a digital image is translated to a physical artifact of the same image (a digital image is translated to a physical copy of the same item). In some examples, the first set of images can be captured within the AR environment directly whereby a user initiates the image capturing process of a digital image, within a physical environment, using one or a plurality of methods. In some examples, the first set of images can be captured within the VR environment directly whereby a user initiates the image capturing process of a digital image, within a digital environment, using one or a plurality of methods). In some examples, the first set of images can be captured within the physical environment using one or a plurality of systems, and translated to a physical artifact of the same image in a VR environment. In some examples, the first set of images can be captured within the AR environment directly whereby a user initiates the image capturing process of a digital image, within a physical environment, using one or a plurality of methods, and that image is translated to a digital copy within a VR environment that can also be captured using one or a plurality of methods.

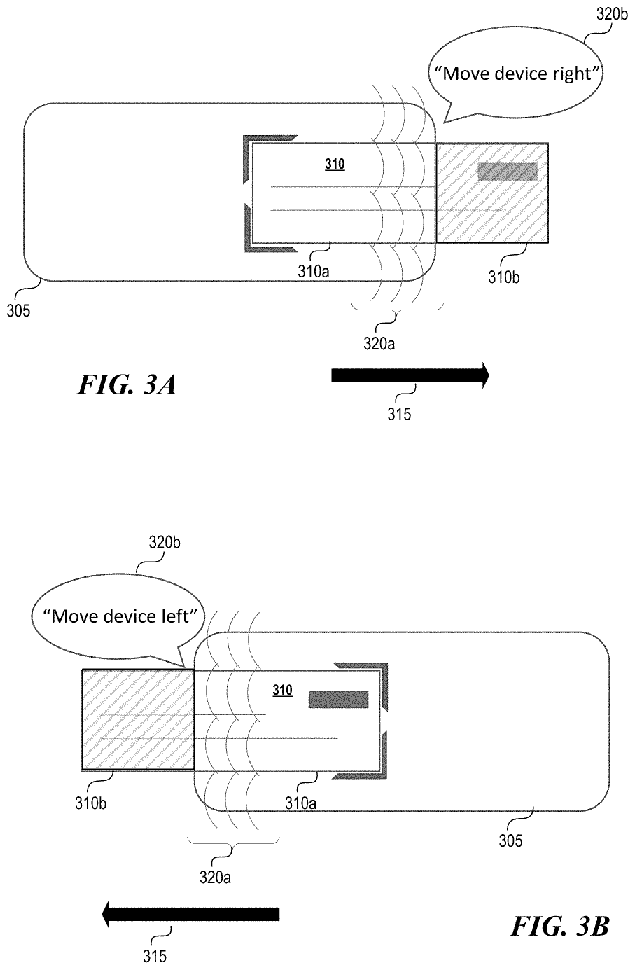

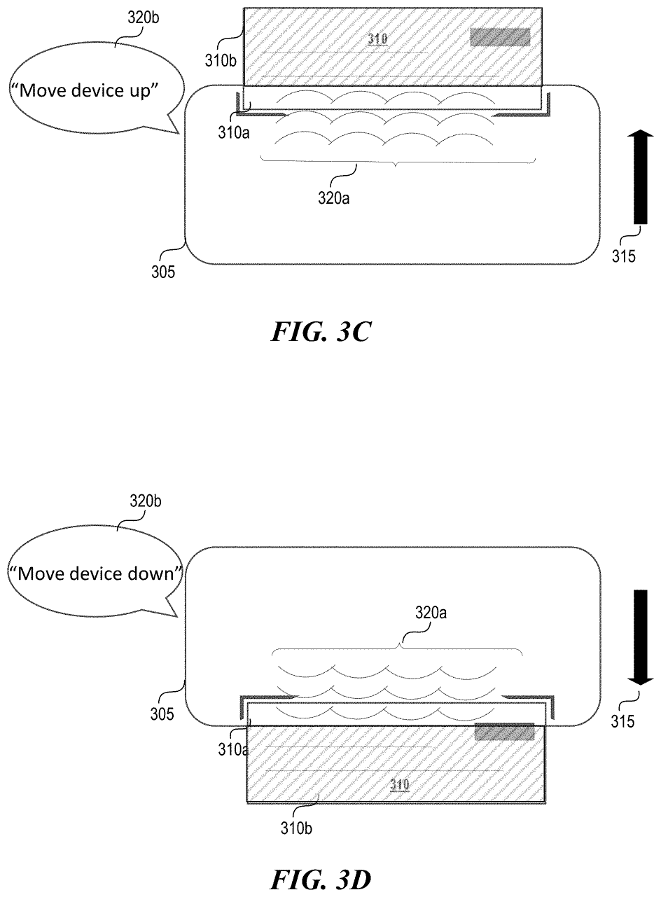

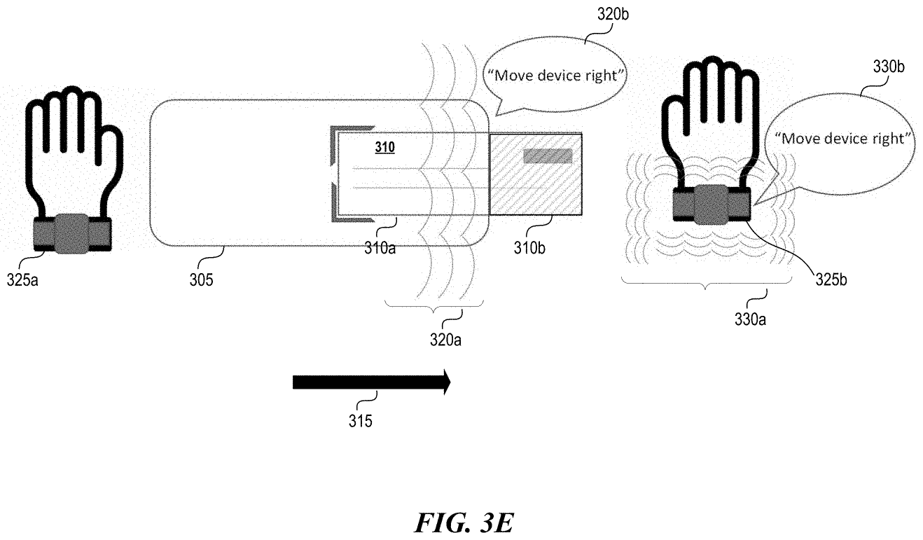

In some implementations, the set of images are retrieved from one or more videos of the object. At block 210, process 200 evaluates the first set of images to identify object attributes, such as edges, corners, sides, brightness, color, hue, luminosity, intensity, text on object, images on object, depth, presence/absence of logos, presence/absence of digital keys, presence/absence of digital tokens, presence/absence of physical watermarks, presence/absence of digital watermarks, indentations, truncated domes (braille), punch holes, presence/absence of barcodes, presence/absence of QR codes, presence/absence of movement (for example, a digital watermark that moves—or doesn't move—in such a way that confirms the object is the object based on confirmation of the presence/absence of movement within, around, on top of, behind the watermark), and so on. Process 200 can then use the identified object attributes to form/extrapolate other attributes of object, such as the object's boundary, edge, side, corner, count relative to the edge, side, corner, count confirmed in the viewer window, and so on. For example, using images of a portion of a rectangular object (e.g., a check) with some written text, process 200 can identify a boundary of the entire rectangular object. In some implementations, process 200 identifies an image of an object as a complete image when all edges, sides, corners, etc., are confirmed to be recognized, relative to their position within the viewer window, bound within the approved minimums/maximums across the x, y, and z axis. This can help detail how an image could be too far away based on the minimum/maximum bound area but yet shows all four sides, edges, corners, etc.,—the result would be for the user to move the device closer/further away. Process 200 uses the object attributes to identify one or more portions of the object that are not visible in the received first set of images. For example, as illustrated in FIGS. 3A-3D, process 200 can identify that portion 310b of object 310 is not visible in the first set of images (portion 310a of the object is visible).

At block 215, process 200 can compute a revised position of the capturing device relative to the object, such that images taken at the revised position will yield more complete images of the object. Additionally, or alternatively, at block 220 process 200 can identify/compute a direction in which the capturing device is to be repositioned relative to the object in order to capture revised images of the object. The direction of movement can be in the X direction, Y direction, Z direction, or any combination thereof. The direction of movement can be computed as a vector signifying the direction (up, down, right, left, near, away, etc.) and a quantity of relative displacement. Other examples of direction of movement include, but are not limited to North/due North, South/due South, East/due East, West/due West, permutation of directions including examples like; Northeast, North Northeast, Southwest, South Southwest, Zenith, Nadir, port, starboard, closer, farther, and so on. In some implementations, process 200 determines the direction of movement based on an application that invoked the capture of images of the object and/or an application that will consume the images. For example, when an application to scan a government ID (e.g., a driver's license) invokes a camera of a mobile device to capture images of the government ID (i.e., the object), process 200 can determine that images at higher resolution are desired. As a result, process 200 can identify a direction in the Y-Z plane such that better resolution images of the driver's license can be captured. Process 200 can be applied to the capturing of other objects like credit/debit cards, paperwork (e.g., resolution of the words/images), QR codes, check images, etc. Resolution can be confirmed by image sharpness, blurriness, diffractions, PPI scale, DPI scale, ground sample distance (GSD), color profile, spatial resolution, temporal resolution, radiometric resolution, pixel count, and so on.

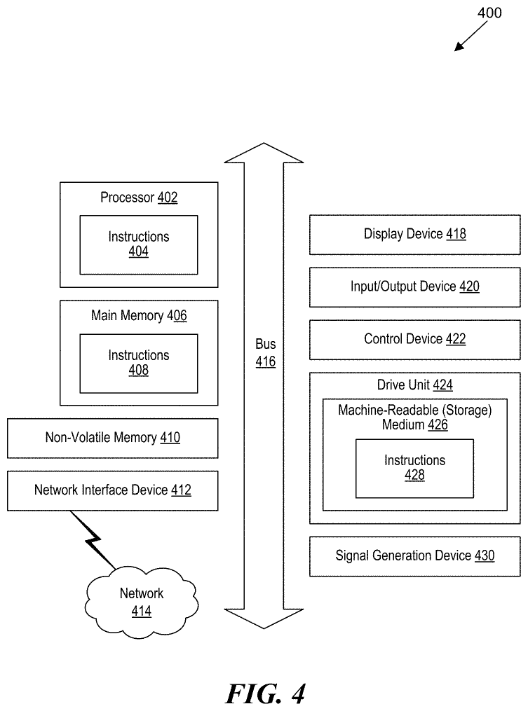

The direction of movement can be of the capturing device, the object, or one or more devices other than the capturing device or the object. For example, as illustrated in FIGS. 3A-4, the direction of movement 315 is of a capturing device integrated into the mobile device 305 while the object 310 is kept steady. As another example, the direction of movement can be of the object 310 while the mobile device 305 is kept steady. In some implementations, process 200 can identify two or more directions of movement, for each of the capturing device, the object, and/or other devices.

Using the computed direction of movement (and/or the capturing device or object or both that need to be moved), process 200 can determine one or more output devices to which the accessible guidance instructions will be transmitted. Examples of output devices include, but are not limited to: haptic devices, speakers, LED lights, graphical user interfaces, braille reader, speaker/headphone, video card, sound card, vibratory transducers, tactile haptics, lights (generally speaking), GPS, and so on. The output device(s) could be integrated into the mobile device or device(s)/user equipment other than the mobile device. For example, as illustrated in FIG. 3E, process 200 identifies two smart watches 325a and 325b that are communicatively coupled to capturing device 305. Process 200 can then select device 325b to which it will transmit instructions (as discussed below).

At block 225, process 200 transmits a set of instructions to the identified/selected output devices to enable repositioning of the capturing device relative to the object. The set of instructions identifies a physical direction of movement corresponding to the computed at least one direction (e.g., right, left, up, down, near, away, and so on). The instructions enable the selected output devices to emit signals in one or more of the following forms: haptic/tactile signals, audio signals, video signals, image signals, visual indicators (e.g., blinking lights), motion signals, dimming/flashing/blinking lights, color signals (ombre color movement), braille reader (truncated domes) signals, and so on. As discussed above, the direction of movement can be of the capturing device, the object, or one or more devices other than the capturing device or the object. As a result, transmitting the set of instructions can facilitate movement of the capturing device(s) relative to the object or facilitate movement of the object relative to the capturing device(s), or both. In some implementations, the output devices process the received instructions before emitting one or more signals, as discussed above. For example, the instructions can be processed in one or more of the following manners before/after they are transmitted to the output device(s): security verification, image confirmation (imagine a captured image being compared against a collection of like-typed images—check image compared against images of checks to confirm that it is indeed a check, etc.), tokenization (converting the digital image to a token for use in blockchain or alternative system), image encryption, visual encryption (for example, where the image, like a check image, is being scanned by the user and visually blurred so the contents of the image is not shown directly in the viewer. The captured image will show the actual contents but is encrypted prior to being saved), and so on.

For example, as illustrated in FIGS. 3A-3D, the mobile device (i.e., the selected output device in these examples) can emit haptic signals 320a and/or audio signals 320b (and/or other signals, such as visual signals and motion signals) to facilitate movement of the capturing device 305 relative to the object 310. As another example, FIG. 3E illustrates that, in addition to (or in lieu of) the mobile device, a wearable device (e.g., smart watch 325b) on a user's right hand emits haptic signals 330a and/or audio signals 330b to facilitate movement of the capturing device 305 in the right direction relative to the object 310. While FIG. 3E illustrates a smart watch, one of skill in the art would understand that other wearables that incorporate output devices, such as fitness bands, haptic gloves, haptic clothing, and so on, can be used. Any wearable haptic device could emit a haptic signal that can be associated with direction. Another example is a wearable haptic strap could be placed on any location on the wearer and provide haptic direction. Additionally, haptic tactile technology can mimic textures using vibrations and when used in this example would allow the user to ‘feel’ where the item is in the viewer window. Haptic gloves can be used within the ARNR space to cover a virtual world (e.g., Metaverse) implementation where a user is wearing one or more haptic sensors and the system emits haptic, visual, and/or audio signals.

Once the capturing device is repositioned relative to the object, at block 230, process 200 can capture a second set of images of the object. At block 235, process 200 can generate and/or store one or more digital versions of the object using the second set of images, the first set of images, or a combination of the two. In some implementations, the second set of images can be used as comparisons against the previous image(s) to ensure the best image or images are used. The second set of images can be used to confirm the validity of the previous image or images. The second set of images can be used to confirm additional security measures based on implemented protocols (imagine image one confirms the sides, image two confirms content, image three confirms security tokenization and all, some, or none, confirm the validity of any one of the images).

Computer System

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, video display device 418, an input/output device 420 (e.g., cameras, speakers, haptic sensors, haptic devices, LED lights, etc.), a control device 422 (e.g., keyboard and pointing device), a drive unit 424 that includes a machine-readable (storage) medium 426, and a signal generation device 430, all of which are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in this specification can be implemented.

The computer system 400 can take any suitable physical form. For example, the computing system 400 can share a similar architecture as that of a user equipment, a server computer, personal computer (PC), tablet computer, mobile telephone, game console, music player, wearable electronic device, network-connected (“smart”) device (e.g., a television or home assistant device), ARNR systems (e.g., head-mounted display), or any electronic device capable of executing a set of instructions that specify action(s) to be taken by the computing system 400. In some implementation, the computer system 400 can be an embedded computer system, a system-on-chip (SOC), a single-board computer system (SBC) or a distributed system such as a mesh of computer systems or include one or more cloud components in one or more networks. Where appropriate, one or more computer systems 400 can perform operations in real-time, near real-time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 406, non-volatile memory 410, and machine-readable (storage) medium 426) can be local, remote, or distributed. Although shown as a single medium, the machine-readable (storage) medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computing system 400. The machine-readable (storage) medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### Remarks

The terms “example,” “embodiment,” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms in either this application or in a continuing application.

We claim:

1. A mobile device that outputs accessible guided directions for capturing images, the mobile device comprising:
a capturing device to capture a set of images of an object;
at least one hardware processor;
at least one non-transitory memory, coupled to the at least one hardware processor and storing instructions, which when executed by the at least one hardware processor perform a process, the process comprising:
evaluating the set of images captured by the capturing device to identify at least one attribute of the object comprising one or more of: an edge of the object, a side of the object, or a corner of the object;
identifying a portion of the object that is not visible in the captured set of images based on the identified at least one attribute of the object;
using the identified portion of the object that is not visible in the captured set of images, computing at least one direction in which the capturing device is to be repositioned relative to the object in order to capture a revised set of images of the object;
using the computed at least one direction, selecting one or more output devices from a set of output devices comprising at least one of: a haptic device or a speaker; and
transmitting a set of instructions to the selected one or more output devices to enable the repositioning of the capturing device relative to the object,
wherein at least a portion of the set of instructions are outputted via the selected one or more output devices, and
wherein the set of instructions identify a physical direction of movement corresponding to the computed at least one direction.

2. The mobile device of claim 1, wherein the set of instructions, when executed by the at least one hardware processor, further performs a process comprising:
capturing, using the capturing device, the revised set of images of the object after the capturing device is repositioned relative to the object.

3. The mobile device of claim 1, wherein the instructions, when executed by the at least one hardware processor, further perform a process comprising:
capturing, using the capturing device, the revised set of images of the object after the capturing device is repositioned relative to the object; and
using the revised set of images to generate and store a digital version of the object.

4. The mobile device of claim 1, wherein transmitting the set of instructions facilitates movement of the capturing device relative to the object.

5. The mobile device of claim 1, wherein transmitting the set of instructions facilitates movement of the object relative to the capturing device.

6. The mobile device of claim 1, wherein the set of instructions enables the selected one or more output devices to emit signals in one or more of following forms: a set of haptic signals, a set of audio signals, a set of video signals, a set of visual indicators, a set of image signals, or any combination thereof.

7. The mobile device of claim 1, wherein the computed at least one direction comprises a direction in an X axis, a Y axis, a Z axis, or any combination thereof.

8. The mobile device of claim 1, wherein the object is a check.

9. The mobile device of claim 1, wherein the set of output devices comprises a graphical user interface.

10. The mobile device of claim 1, wherein at least one output device in the set of output devices is integrated into the mobile device.

11. The mobile device of claim 1, wherein at least one output device in the set of output devices is integrated into a device other than the mobile device.

12. The mobile device of claim 1, wherein at least one output device in the set of output devices is communicatively coupled to the mobile device.

13. The mobile device of claim 1, wherein the at least one attribute of the object further comprises one or more of: color, hue, brightness, luminosity, or intensity.

14. The mobile device of claim 1, wherein the at least one direction in which the capturing device is to be repositioned relative to the object is determined in part on attributes of an application invoking the capturing device to capture the set of images of the object.

15. A computer program product for providing accessible guided directions for capturing images, the computer program product being embodied in a non-transitory computer readable medium and comprising computer instructions for:
receiving a first set of images of an object;
evaluating the first set of images to identify at least one attribute of the object comprising one or more of: an edge of the object, a side of the object, or a corner of the object;
using the identified at least one attribute of the object, computing at least one direction in which a capturing device is to be repositioned relative to the object in order to capture a revised set of images of the object; and
using the computed at least one direction, transmitting a set of instructions to enable the repositioning of the capturing device relative to the object,
wherein the set of instructions identify one or more physical directions of movement corresponding to the computed at least one direction.

16. The computer program product of claim 15, wherein the computer instructions further comprise: identifying a portion of the object that is not visible in the first set of images based on the identified at least one attribute of the object.

17. The computer program product of claim 16, wherein the computed at least one direction is based on the identified portion of the object that is not visible in the first set of images.

18. The computer program product of claim 15, wherein the computer instruction further comprises:
using the computed at least one direction, selecting one or more output devices from a set of output devices comprising at least one of: a haptic device or a speaker; and
transmitting a set of instructions to the selected one or more output devices to enable the repositioning of the capturing device relative to the object,
wherein at least a portion of the set of instructions are outputted via the selected one or more output devices.

19. A method for providing accessible guided directions for capturing images, the method comprising:
receiving a first set of images of an object;
evaluating the first set of images to identify at least one attribute of the object comprising one or more of: an edge of the object, a side of the object, or a corner of the object;
using the identified at least one attribute of the object, computing at least one direction in which a capturing device is to be repositioned relative to the object in order to capture a revised set of images of the object; and
using the computed at least one direction, transmitting a set of instructions to enable the repositioning of the capturing device relative to the object,
wherein the set of instructions identify one or more physical directions of movement corresponding to the computed at least one direction.

20. The method of claim 19 further comprising:
using the computed at least one direction, selecting one or more output devices from a set of output devices comprising at least one of: a haptic device or a speaker; and
transmitting a set of instructions to the selected one or more output devices to enable the repositioning of the capturing device relative to the object,
wherein at least a portion of the set of instructions are outputted via the selected one or more output devices.
